(19) United States
(12) Patent Application Publication
(10) Pub. No.: US 2015/0041534 A1
(43) Pub. Date: Feb. 12, 2015

(54) ELECTRONIC PAYMENT TRANSPONDER

(71) Applicant: 1 Oak Technologies, LLC, Fort Collins, CO (US)

(72) Inventors: Gary A. Rayner, Henderson, NV (US); Aaron Finch, Fort Collins, CO (US); Adam D. Center, Fort Collins, CO (US); Jeffrey D. Schwartz, Loveland, CO (US)

(73) Assignee: 1 Oak Technologies, LLC, Fort Collins, CO (US)

(21) Appl. No.: 14/185,247

(22) Filed: Feb. 20, 2014

Related U.S. Application Data
(60) Provisional application No. 61/863,209, filed on Aug. 7, 2013.
(60) Provisional application No. 61/867,374, filed on Aug. 19, 2013.
(60) Provisional application No. 61/877,017, filed on Sep. 12, 2013.
(60) Provisional application No. 61/897,055, filed on Oct. 29, 2013.

(51) Int. Cl. G06Q 20/32

(52) U.S. Cl. CPC G06Q 20/327
USPC 235/380

(57) ABSTRACT

A transponder for facilitating financial transaction communications is provided. The transponder includes a detector, a processing module, and a magnetic field source. The detector detects a first time varying magnetic field generated by a mobile electronic device. The first time varying magnetic field is encoded with financial account information. The processing module decodes the detected time varying magnetic field to recover the financial account information. The magnetic field source generates a second time varying magnetic field for detection by a magnetic read head of a point-of-sale terminal. The second time varying magnetic field is modulated with the recovered financial account information according to a sequence that corresponds to a standardized format for encoding a magnetic strip of a credit card readable by the magnetic read head of the point-of-sale terminal.

### CROSS REFERENCE TO RELATED APPLICATIONS

This application claims priority to U.S. Provisional Patent Application Ser. No. 61/863,209, filed Aug. 7, 2013, U.S. Provisional Patent Application Ser. No. 61/867,374, filed Aug. 19, 2013, U.S. Provisional Patent Application Ser. No. 61/877,017, filed Sep. 12, 2013, and U.S. Provisional Patent Application Ser. No. 61/897,055, filed Oct. 29, 2013, the entireties of which are incorporated by reference herein.

### FIELD

The present application relates to apparatuses, systems, and methods for communicating information for financial transactions.

### BACKGROUND

In recent decades, it has become increasingly common to conduct financial transactions using payment cards such as credit cards, debit cards, prepaid cards, automatic teller machine (ATM) cards, and gift cards. These types of payment cards commonly include a magnetic stripe that contains account data. The magnetic stripes store data by selectively altering the magnetism of tiny iron-based magnetic particles on a band of magnetic material that makes up the stripe. The magnetic stripe, which is also sometimes called a magnetic strip or magstripe, is typically magnetically encoded or programmed with a variety of information, including an account number associated with the card. In addition to payment cards, magnetic stripes are also commonly used for storing information in a number of other applications including on driver's licenses, public transportation tickets, tickets for paid parking lots or garages, and other similar applications where it is desirable to store information to a card or similar substrate.

Although payment cards often have printed or embossed account numbers that can be read from the card manually or visually, payment cards are commonly used by magnetically reading the information from the magnetic stripe. When a transaction is performed using a payment card, the magnetic stripe is typically read by swiping it through, moving it past, or processing it through a point-of-sale (POS) terminal owned or operated by a merchant or other payee. The POS terminal communicates with other devices or systems in order to process or verify the transaction. POS terminals are also sometimes referred to as point-of-service terminals and often perform other functions in addition to the reading and processing of payment cards. In one example, a POS terminal may be integrated into a gasoline dispensing terminal to allow customers to use a credit or debit card at the terminal to purchase gasoline.

A POS terminal typically has one or more magnetic heads that read information from the magnetic stripe of the payment card as the card is swiped past or near the magnetic head(s). The POS terminal often transmits at least some of the information read from the magnetic stripe, along with information about the transaction, to another entity for processing of the transaction, approval of the transaction, and/or to initiate transfer of funds to settle the transaction. POS terminals are implemented in many different forms including complex computing systems with many other functions, standalone countertop devices with few other functions, and in other implementations with varying levels of functionality and complexity. Merchants often have significant tangible and/or intangible investment in their POS terminals in the form of hardware costs, employee training costs, employee familiarity, comfort level, efficiency, setup costs, physical installation costs, and/or costs of interfacing the POS terminals with other devices or systems.

The ubiquity of mobile phones, smartphones, tablet computers, and related devices, along with their technological advancements, has triggered a number of different initiatives to implement electronic mobile payment systems and solutions. Electronic mobile payment generally refers to performing financial payments, or other types of transactions, via an electronic communication conducted between a mobile electronic device and a POS terminal, or other payment processing system. The electronic mobile payment is performed as an alternative to use of a physical payment card. Electronic mobile payment may also be referred to as mobile money, mobile money transfer, e-wallet, or mobile wallet. Upgrading or replacing existing POS terminals and payment systems to accommodate mobile payment solutions or systems is a hurdle to adoption of the technologies due to the existing infrastructure and installed base of millions of POS terminals.

In addition, the apparatuses and methods of communication disclosed herein may be used for other applications. For example, the methods disclosed herein may be used to perform communication between an electronic device and a security device, a vehicle, a computer, a communication network, and/or another type of electronic device.

### SUMMARY

A transponder for facilitating financial transaction communications is provided. The transponder includes a detector, a processing module, and a magnetic field source. The detector detects a first time varying magnetic field generated by a mobile electronic device. The first time varying magnetic field is encoded with financial account information. The processing module decodes the detected time varying magnetic field to recover the financial account information. The magnetic field source generates a second time varying magnetic field for detection by a magnetic read head of a point-of-sale terminal. The second time varying magnetic field is modulated with the recovered financial account information according to a format or sequence that corresponds to a standardized format for encoding a magnetic strip of a credit card readable by the magnetic read head of the point-of-sale terminal.

The techniques introduced herein also include methods, systems, and other apparatuses. The techniques introduced herein may also include non-transitory machine-readable storage media storing instructions that, when executed by one or more computer processors, direct the one or more computer processors to perform the methods, variations of the methods, or other operations described herein. While multiple embodiments are disclosed, still other embodiments will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

The techniques disclosed herein are described and explained through the use of the accompanying drawings in which:

FIG. 1 illustrates a system for performing a wireless electronic payment in accordance with the techniques introduced herein;

FIG. 2 illustrates devices for performing a financial transaction in accordance with the techniques introduced herein;

FIG. 3 illustrates devices for performing a financial transaction in accordance with the techniques introduced herein;

FIG. 4 illustrates a transponder for performing an electronic payment in accordance with the techniques introduced herein;

FIG. 5 illustrates an electronic payment system for performing transactions in accordance with the techniques introduced herein;

FIG. 6 illustrates a method of performing an electronic payment in accordance with the techniques introduced herein;

FIG. 7 illustrates a transponder attached to a POS terminal;

FIG. 8 illustrates devices for performing a financial transaction in accordance with the techniques introduced herein; and

FIG. 9 illustrates a computer system that may be using in accordance with the techniques introduced herein.

### DETAILED DESCRIPTION

In the following detailed description, various specific details are set forth in order to provide an understanding of and describe the methods, systems, apparatuses, and techniques introduced herein. However, the methods, systems, apparatuses, and techniques may be practiced without the specific details set forth in these examples. Various alternatives, modifications, and/or equivalents will be apparent to those skilled in the art without varying from the spirit of the introduced methods, systems, apparatuses, and techniques. For example, while the examples described herein refer to particular features, the scope of this solution also includes techniques and implementations having different combinations of features and embodiments that do not include all of the described features. Accordingly, the scope of the techniques and solutions introduced herein are intended to embrace all such alternatives, modifications, and variations as fall within the scope of the claims, together with all equivalents thereof. Therefore, the description should not be taken as limiting the scope of the invention, which is defined by the claims.

Many of the apparatuses, methods, systems, and techniques disclosed herein are discussed in terms of credit cards, debit cards, and POS terminals. However, it should be understood that the methods, apparatuses, systems, and techniques disclosed herein may also be used in other applications that conventionally use magnetic stripes to store and/or transfer information. For example, the apparatuses, methods, systems, and techniques disclosed herein may be used to perform transactions where debit cards, gift cards, prepaid cards, and/or ATM cards are conventionally used. In addition, the methods, apparatuses, systems, and techniques may also be used in other, non-financial applications that make use of magnetic stripes and magnetic stripe readers. For example, using the techniques disclosed herein, an electronic device can also be used to store and transmit information conventionally stored on magnetic stripes in other applications such as driver's licenses, identification cards, identification badges, membership cards, gate passes, event tickets, parking tickets, and/or transit passes. Many other applications and uses are possible. In addition, the communication technologies described herein may be used in other applications as described in further detail below.

Financial transactions between merchants and customers are often performed using payment cards such as credit cards, debit cards, prepaid cards, ATM cards, and/or gift cards having magnetic stripes. Payment cards are often read or processed using a POS device, a POS terminal, or system. POS terminals are also often used to perform other functions in addition to the reading and processing of payment cards, such as, for example, scanning bar codes on products, retrieving product prices, calculating transaction amounts, and computing tax.

Payment cards with magnetic stripes are commonly implemented on a plastic substrate that contains a stripe of the magnetic material across the back. The magnetic stripe may be magnetically written or programmed with a variety of information in a variety of formats. Magnetic stripes are also used to store data in a number of other applications such as, for example, on driver's licenses, event tickets, membership cards, transit passes, and parking passes.

In some cases, a single magnetic stripe may contain multiple sets of information. For compatibility purposes, the information may be stored according to a standard such as ISO/IEC-7813 and/or ISO/IEC-7811. According to these standards, up to three tracks of information are contained in the magnetic stripe. When a card is swiped in or received by a POS terminal, any combination of the three tracks may be read. In this particular standard, the minimum account information needed to complete a transaction is typically present on both the first and the second track. The first track often has a higher bit density than the second track and may also contain alphabetic text such as the account owner's name. The third track is often unused and may not even be physically present on the card in some cases. The first track is typically written in a format known as DEC sixbit plus odd parity.

The information in the first track may be contained in several formats: format A, which is reserved for proprietary use of the card issuer; format B, which is described below; formats C-M, which are reserved for use by American National Standards Institute (ANSI) Subcommittee X3B10; and formats N-Z, which are available for use by individual card issuers. In one common implementation, format B includes the following fields in the following order: a start sentinel, a format code, a primary account number, a field separator, a name, a field separator, an expiration date, a service code, discretionary data, a PIN verification value, a card verification value or card verification code, an end sentinel, and a longitudinal redundancy check.

When a transaction is performed using the payment card, the stored information is typically read from the magnetic stripe by swiping it in, past, or through a POS terminal. The POS terminal typically has one or more integrated or embedded magnetic heads or sensors that read information from the magnetic stripe of the payment card as the card is swiped past the head(s) or sensor(s). In some configurations, the payment card may be held stationary while one or more sensors or heads are moved with respect to the card. The POS terminal often transmits at least some of the information read from the magnetic strip, along with information about the transaction, such as the total for the transaction, to one or more other entities. The other entities may be involved in the approval of the transaction, processing of the transaction, and/or the transfer of funds to settle the transaction.

Many people frequently carry mobile or handheld electronic devices with them. These devices include, but are not limited to: cell phones, smartphones, personal digital assistants (PDAs), tablet computers, digital audio players, multimedia players, Internet access devices, Wireless Fidelity (WiFi®) access devices, notebook computers, global positioning satellite (GPS) receivers, and/or electronic gaming devices. It has become desirable to implement payment solutions in which a user can complete a transaction electrically or electronically using one of these devices. Performing transactions electronically may provide a variety of benefits such as: the convenience of not needing to carry a physical payment card, improved account security, improved recordkeeping, and/or efficiency. Various electronic payment solutions may also be referred to as mobile money, mobile money transfer, e-wallet, or mobile wallet. In recent years, a number of different approaches to or standards for electronic payment solutions have been proposed (e.g., Google Wallet®, Visa Pay Wave®). In order to achieve one or more of the benefits described above, many of these electronic payment solutions seek to accomplish communication between the electronic device and the POS terminal using one or more wireless or contactless technologies, thereby eliminating the need for the consumer to carry or produce a payment card.

Unfortunately, the majority of the large installed base of POS terminals does not have the capability for performing contactless and/or wireless electrical or electronic communications with electronic devices commonly carried by customers. Therefore, many, if not all, of the proposed contactless or wireless payments solutions require many of the existing POS terminals to be replaced, modified, or upgraded. Merchants and other POS terminal owners/operators are often resistant to upgrade due to hardware costs, employee training costs, familiarity with existing systems, downtime, installation costs, programming costs, and/or the overhead and indirect effects of switching from one device or system to another. Since merchants are slow to adopt these technologies, it is difficult to determine which of the approaches will evolve to be the dominant standard(s). Without a dominant standard(s), electronic device manufacturers may be reluctant to implement any necessary hardware or software in electronic devices because it is unclear which standard or solution should be implemented. Even if the hardware and software is available, consumers may still be slow to adopt due to the lack of a clear leading technology and/or due to the small number of merchant locations at which it can be used. Consequently, it is desirable to implement an electrical or electronic payment solution that utilizes features of existing POS terminals and electronic devices with little or no hardware changes.

Apparatuses, systems, methods, and techniques are introduced herein that resolve the shortcomings discussed above. In one example, a transponder facilitates electronic communication between a mobile electronic device and a POS terminal that do not have the capability to communicate with each other directly. In this example, the mobile electronic device electronically transmits payment or account information for a transaction using VLF (very low frequency) radio signals or using a time-varying magnetic field. The term “VLF” refers to radio frequencies in the range of 3 kHz to 30 kHz. In some cases, the mobile communication device may be capable of producing VLF radio signals using hardware present in the mobile communication device for purposes other than VLF communications. In other words, the mobile electronic device may be capable conducting these types of communications without a need specialized hardware for performing electronic or contactless transactions, such as a near field communication (NFC) transmitter.

In the example above, the mobile communication device generates a VLF radio signal or time-varying magnetic field modulated to include the account information stored in the electronic device. The account information can then be received by a transponder configured to receive the transmission and demodulated to recover the account information from the signal. The transponder then generates a magnetic field that is modulated to include the account information. If the transponder is in proper proximity to a point-of-sale (POS) terminal comprising a magnetic read head, or a magnetic field sensor of another type, the POS terminal can detect the modulated magnetic field from the transponder. The POS terminal may then demodulate the detected magnetic field to determine the payer account information. A transaction can then be processed by the POS terminal in a conventional manner similar to how the transaction would have been processed if a conventional payment card with a magnetic stripe had been swiped in the POS terminal.

A read head in a POS terminal is designed to read or detect magnetic fields from a magnetic stripe that is moved by or positioned near the head. However, as disclosed herein, the read head can be exposed to magnetic fields in different ways in order to accomplish a similar result. Every device that conducts electricity through a conductor produces or releases electromagnetic emanations. While these electromagnetic emanations are often unwanted or unintended, they can sometimes be used for beneficial purposes. Magnetic fields form in concentric circles around the wire or conductor that is carrying the current. The direction of a magnetic field resulting from a current in a conductor can be determined by using the right hand rule or the right hand grip rule with respect to the direction of the current.

An electrical circuit carrying a time-varying current produces electromagnetic signals having characteristics related to the amplitude and rate of change of the current. The strength of a magnetic field resulting from current flowing through a wire or other conductor varies with the amount of current, as well as with distance from the wire or conductor. When the wire or conductor is in the shape of a loop, the magnetic field is concentrated inside the loop. The magnetic field outside the loop becomes weaker. If the conductor is shaped into multiple closely spaced loops, also known as a coil, the concentration of the field inside the loops is enhanced. Forming the loops or coil around a core containing an iron material further strengthens the magnetic field. Time-varying electrical currents produce time-varying electromagnetic fields. Because the strength and/or the direction of a resulting magnetic field can be changed over time, the magnetic field can be modulated or encoded to contain data for data communication purposes.

In order to mimic or emulate the sequence of magnetic fields detected by a read head of a POS terminal when a conventional payment card with a magnetic stripe is passed by the read head, another device may generate a magnetic field and vary it over time in a pattern that emulates the magnetic field experienced by the read head when a card is swiped in the conventional manner. Manipulating the magnetic field may include activating and deactivating the magnetic field, toggling the direction of the magnetic field, and/or changing the amplitude of the magnetic field. Other methods of manipulating or modulating the magnetic field to contain or communicate payment data are possible.

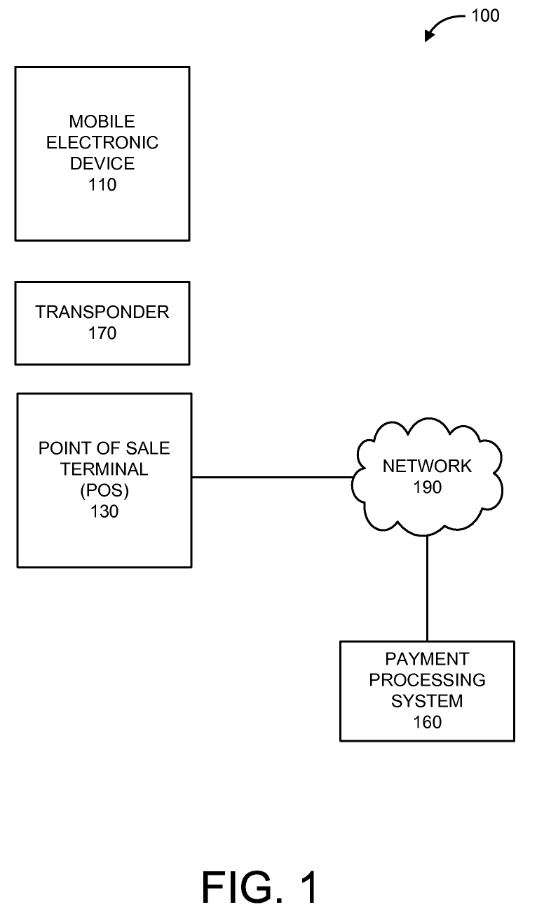

FIG. 1 illustrates system 100 for performing a wireless electronic payment in accordance with the techniques introduced herein. System 100 includes mobile electronic device 110, transponder 170, POS terminal 130, payment processing system 160, and network 190. System 100 may also include other devices or systems involved in the processing of the payment.

Mobile electronic device 110 may be any handheld or mobile computing device such as a cellular phone, a mobile phone, a smartphone, a tablet computer, a notebook computer, an Internet access device, a WiFi® access device, an electronic book reader, a personal digital assistant (PDA), a phablet, a GPS receiver, an audio player, and/or a multimedia player. Mobile electronic device 110 is capable of storing account information related to a payment account in an electrical, electronic, or digital memory. In some cases, the memory may be in the form of a card or module that is readable by electronic device 110 and may be removed from electronic device 110.

The stored account information includes an account number or an account identifier of some type. In some cases, the account information may also include a name of the owner or party responsible for the account. The account information may also include other data. For example, the account information may include some or all of the other information typically stored on a magnetic stripe of a credit card, an ATM card, a debit card, a gift card, and/or a prepaid card. The account information may also include data related to an account balance, transaction history, expiration, or other data related to use of funds associated with the account. The account information may be received by mobile electronic device 110 through manual entry at a user interface of mobile electronic device 110, may be loaded via a removable memory device, may be received from another device over a wired connection, or may be received from another device through a wireless connection such as, for example, through a cellular phone data network or a WiFi® access point.

POS terminal 130 comprises any device or system configured for receiving or processing payment information for a financial transaction. In one common implementation, POS terminal 130 is a computer system or a dedicated device for reading and processing information from credit cards, debit cards, or another type of transaction card. POS terminal 130 may be a dedicated system, a stand-alone system or may be part of a computer system that also performs other functions. For example, POS terminal 130 may also perform functions such as: reading product information, identifying products, reading bar codes, retrieving pricing information, receiving product or order entry information, weighing products, computing transaction totals, computing tax, updating inventory information, applying discounts, and/or generating documentation, such as receipts. In some configurations, POS terminal 130 may be a peripheral device that is attached to a multipurpose computing device such as a computer, a tablet computer, a phablet (phone/tablet), a notebook computer, or a mobile phone. In some cases, POS terminal 130 reads payment information from a payment device or card, computes or receives transaction information (e.g., a purchase amount, a card expiration date), and transmits this information to another system or entity for verification of the information and/or approval of the transaction.

In one configuration, POS terminal 130 includes a magnetic stripe reader configured for reading magnetic stripes on payment cards according to a standard. The standard may include information related to where the stripe will physically be located on a substrate as well as information about what data will be encoded on the stripe and the format for the encoding. There are a number of different formats used for encoding information on magnetic stripes. ISO/IEC-7811 and ISO/IEC-7813 are common examples of standards used to configure POS terminals, such as POS terminal 130, to read information from payment cards in a predictable and reliable manner. Other standards may be used in other applications.

The encoding format designated in ISO/IEC-7811 is sometimes referred to as “F2F” or “Aiken biphase” encoding. The F2F encoding format allows data written to a magnetic stripe serially to be self-clocking when it is read. Bits are encoded serially on the magnetic stripe using a series of magnetic flux transitions. Each bit of data on a track has a specified physical length or space on the magnetic stripe. Flux transitions are located at the edge of each bit area and also in the center of each “1” bit. As the card with the magnetic stripe is swiped in or received by POS terminal 130, the magnetic stripe passes near a magnetic sensor or head. The magnetic flux transitions on the stripe are converted into a series of alternating positive and negative pulses. After determining which flux transitions represent the edges of a bit, digital values representing ones and zeros can be differentiated by the presence or absence of a pulse in the center of the bit. It should be understood that many other data encoding formats are possible and the techniques introduced herein are not to be limited to any particular encoding format, data format, and/or card form factor.

Transponder 170 is an apparatus for performing communications between mobile electronic device 110 and POS terminal 130. Transponder 170 receives or detects an electrical, electronic, magnetic, optical, acoustic, mechanical, or other type of communication and retransmits information from that the communication using another type of electrical, electronic, or optical communication. In other words, transponder 170 is a communication adapter that enables communication between two devices or systems that may not otherwise be capable of communicating with each other due to incompatible communication capabilities. In addition to changing the type or format of the communication, transponder 170 may also modify or reformat the communication. Transponder 170 may comprise analog electrical components, digital electronic components, optical components, a receiver, a transmitter, a computer processor, memory, and/or an electrical interface. Transponder 170 may operate using firmware, software, or another type of machine readable instructions executed by a computer processor. Transponder 170 may also comprise other components such as a battery, a power supply, an enclosure, a frame, an indicator, and/or an electromechanical connector. In some cases, transponder 170 may have a mechanical configuration that allows it to be attached to POS terminal 130 or otherwise held in a preferable position with respect to POS terminal 130.

Payment processing system 160 comprises any system, or portion of a system, for processing financial transactions or financial transaction requests. Payment processing system 160 may be a computer, a group of computers, a server, a group of servers, a mainframe, an application specific computing device, a distributed computing system, a portion of a distributed computing system, or a combination thereof. In the credit card processing industry, an entity operating payment processing system 160 may be referred to as an “acquirer” and/or may perform some or all of the same functions as an acquirer. Payment processing system 160 may be configured for performing a number of different aspects of processing a payment card such as: receiving transaction information from a merchant, sending a request to a card issuer, receiving authorizations from card issuers (e.g., banks, credit unions), transmitting authorizations to merchants, processing batches of authorized transactions from merchants, communicating with card networks (e.g., Visa®, American Express®), and/or settling transactions. Many different processes and systems are possible for processing credit, debit, and electronic payments. These processes and systems may involve banks, acquiring banks, card issuers, card networks, and other financial entities in various combinations.

The techniques introduced herein are not to be limited to any particular payment or transaction processing system or environment and may be applied to many types of electronic information exchange systems and ecosystems. Although system 100 is described with respect to POS terminal 130 and financial transactions, the techniques disclosed herein are equally applicable in other devices and systems that conventionally use a magnetic card reader. In one example, the techniques may be used in a security system or an access control system designed to read magnetic stripes on access cards or identification badges. Many other applications are possible such as applications involving driver's licenses, event tickets, transit passes, membership cards, gate passes, parking tickets, and parking passes.

Network 190 may comprise any apparatus, device, system, firmware, software, or combination thereof for communicating digitized data from one location to another. Network 190 may include an intranet, the Internet, a local area network (LAN), a wide area network (WAN), a wireless network, a WiFi® network, a cellular network, a cellular data network, or any other electronic communication path, including combinations thereof. Network 190 may include devices such as servers, switches, routers, and gateways. The devices and systems of FIG. 1 are illustrated as communicating over a single network, network 190. However, communications between the devices and systems may be conducted over multiple networks, separate networks, and/or various combinations of networks, including wireless networks. Network 190 may be interconnected to one or more other networks, such as a wireless communication network. In some situations, network 190 may be a conventional telephone network and POS terminal 130 may communicate with payment processing system 160 and/or other systems using a landline dial-up connection.

In one example of operation of system 100, a user of mobile electronic device 110 wishes to conduct a transaction at a merchant who uses POS terminal 130 to process transactions. In this example, POS terminal 130 is a conventional card processing terminal operated by the merchant and configured to magnetically read data stored on magnetic stripes of credit cards and debit cards that are swiped through POS terminal 130. The cards are read using one or more magnetic read heads. Transponder 170 is positioned in proximity to POS terminal 130 such that magnetic fields generated by transponder can be detected by the one or more read heads of POS terminal 130 even though the fields are not presented to the read heads in the form of a magnetic stripe on a card.

Account information associated with a payment account of the user is stored in mobile electronic device 110. Through a user interface of mobile electronic device 110, the user initiates a payment process. The user may interact with a software program, a software application, or a software “app,” that is executed by one or more computer processing devices of mobile electronic device 110. In response to the user initiating the payment process, mobile electronic device 110 generates payment data that will be communicated to POS terminal 130 via transponder 170. The generated payment data is based on or includes the account information stored in mobile electronic device 110. In some cases, the payment data may include the same types of data typically stored on a magnetic stripe of a credit card or debit card. As discussed in other examples herein, the payment data may have various formats, may be encoded, and/or may be encrypted.

Because mobile electronic device 110 may not be capable may not be capable of generating a magnetic field having characteristics that can be received or read by POS terminal 130, mobile electronic device 110 generates a signal that is receivable by transponder 170. The electrical signal contains the payment data.

In one example, the electrical signal generated by mobile electronic device 110 is a VLF radio signal. The VLF radio signal is modulated or otherwise encoded with the payment data in a format known to transponder 170. The modulated VLF radio signal is generated in response to an input from a user of mobile device 110 indicating that the user wishes to perform a financial transaction.

The modulated VLF radio signal is received by transponder 170. In some cases, the modulated VLF radio signal is relatively weak and mobile electronic device 110 may have to be placed in close proximity to transponder 170 in order for the modulated VLF radio signal to be strong enough to be received by transponder 170. In other cases, the signal strength may be intentionally reduced or minimized in order to reduce the possibility that the modulated VLF radio signal can be received by others. Transponder 170 may have a shelf, tray, slot, or other mechanical feature that guides the user to where mobile electronic device 110 should be placed with respect to transponder 170 in order to achieve communication between the two. Transponder 170 receives the VLF radio signal and demodulates the VLF radio signal to recover the payment data. Transponder 170 then generates a magnetic field that varies according to the payment data and/or is modulated with the payment data.

The magnetic field generated by transponder 170 is sensed or received by the magnetic head or sensor in POS terminal 130. The magnetic field may be sensed by POS terminal 130 even though the head or sensor in POS terminal 130 may be a magnetic head originally configured for reading magnetic stripes on payment cards. The magnetic field generated by transponder 170 is varied in order to emulate or mimic the magnetic field that would be experienced by the magnetic head or sensor of POS terminal 130 when a conventional payment card with the payment data is swiped on or near the magnetic sensor. Transponder 170 may be attached to POS terminal 130 or may be positioned in a fixed location and orientation with respect to POS terminal 130 to improve or optimize the detection of the magnetic field by POS terminal 130. By placing transponder 170 in close proximity to POS terminal 130, the strength of the magnetic field necessary to communicate the payment data from transponder 170 to POS terminal 130 can be reduced or minimized. Reducing the strength of the magnetic field reduces the possibility that the information may be received or intercepted by another party. Reducing the strength of the magnetic field may also reduce the power required to generate and/or reduces the potential for interference with other devices.

Once POS terminal 130 has received the payment data from transponder 170, the remaining processes associated with the transaction may be performed using conventional or known methods using network 190, payment processing system 160, and/or other devices or systems. In some cases, the conventional processes may be varied to accommodate encryption and/or other security features that are implemented in conjunction with the techniques disclosed herein.

Using the techniques disclosed herein, a POS terminal that was initially designed or configured for reading magnetic stripes on conventional payment cards can be used for receiving electronic payments from electronic devices, such as mobile electronic device 110, even though the POS terminal was not originally designed or configured for receiving payment information in this manner. In this way, merchants can receive electronic payments from customers without changing, modifying, or upgrading their POS terminal hardware. Transponder 170 may be attached to or placed adjacent to POS terminal 130 such that POS terminal 130 can receive payment data as described herein while still retaining the capability to read magnetic stripes from payment cards using conventional methods.

The techniques provided herein also enable a user of mobile electronic device 110 to complete transactions without having to carry a conventional payment card, without having to swipe a conventional payment card through POS terminal 130, and/or without having to expose an account number on a payment card to the merchant or an employee of the merchant. The user is also able to complete these types of transactions without the use of or need for supplemental radio frequency (RF) communication hardware or features, such as a near field communication (NFC) transmitter, a Bluetooth transmitter, or a Bluetooth Low Energy transmitter.

In another example, transponder 170 includes a magnetic field sensing module that is configured to detect a time varying magnetic field generated by mobile electronic device 110. The time varying magnetic field is encoded or modulated with an account number and/or other financial or payment data. The time varying magnetic field may be encoded or modulated using one of many known encoding or modulation schemes including frequency shift keying (FSK), phase shift keying (PSK), amplitude shift keying (ASK), frequency modulation (FM), amplitude modulation (FM), and/or others, including combinations thereof. The magnetic field sensing module may also be configured to generate an electrical signal based on the detected and/or demodulated time varying magnetic field. Transponder 170 may also include processing circuitry configured to receive the electrical signal from the magnetic field sensing module and demodulate the electrical signal to recover the financial account information from the electrical signal. The modulation and demodulation processes may include various types of encoding, decoding, encrypting, or decrypting algorithms, including combinations thereof.

In the example above, transponder 170 may also include a magnetic field generation module configured to generate a second time varying magnetic field which can be detected by a magnetic read head of POS 130. The second time varying magnetic field may be modulated with the financial account information according to a format where the format corresponds to a standardized format for encoding a magnetic strip of a credit card readable by the magnetic read head of POS 130. In other words, the second time varying field may be generated by transponder 170 to create a time varying magnetic field in the area of the read head of POS 130 such that mimics the varying magnetic field detected by the read head when a conventional magnetic stripe card is swiped by the read head. In some cases, the polarization of the generated magnetic field is varied according to a pattern to mimic the field that would be experienced at the read head when a conventional card is swiped.

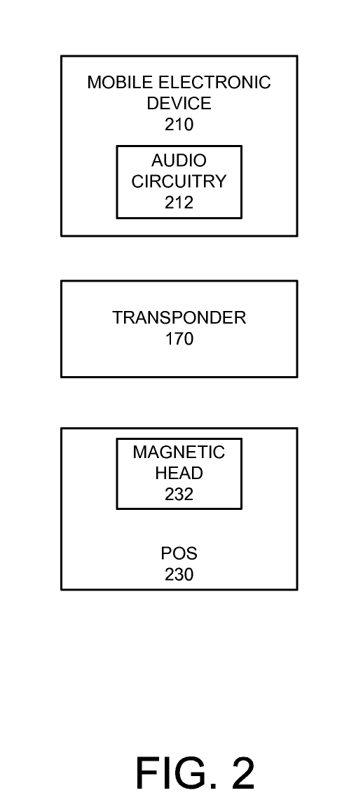

FIG. 2 illustrates devices for performing a financial transaction in accordance with the techniques introduced herein. FIG. 2 includes mobile electronic device 210, POS 230, and transponder 170.

Mobile electronic device 210 is an example of mobile electronic device 110, although other configurations or features are possible. Mobile electronic device 210 includes audio circuitry 212. Audio circuitry 212 includes analog and/or digital electronic components for generating audio signals. For example, mobile electronic device 210 may use audio circuitry 212 to drive a speaker of mobile electronic device 210 (not pictured). However, audio circuitry 212 may also be driven with a signal in the VLF frequency range in order to generate a VLF radio signal. For example, mobile electronic device 210 may drive audio circuitry 212 with a signal in the range of 15 kHz to 20 kHz. Other frequency ranges are possible. Even though mobile electronic device 210 and/or audio circuitry 212 may have not been designed or manufactured for generating radio waves, it may be capable of doing so because the frequency range is near or within the frequency range of audio signals that audio circuitry 212 was designed to generate and transmit to a speaker over electrical conductors. In some cases, the radio waves may be generated in a parasitic manner or may be a result of parasitic oscillation occurring in audio circuitry 212 and/or in other circuitry of mobile electronic device 210. In other examples, the signal generated by mobile electronic device 210 may have a frequency in a range of 30 Hz to 300 Hz, in a range of 300 Hz to 3 kHz, and/or in a range of 3 kHz to 30 kHz.

In one example, mobile electronic device 210 may use audio circuitry 212 to generate a modulated VLF radio signal with a 17 kHz carrier frequency in accordance with the techniques described herein. The speaker of mobile electronic device 210 will also be driven with this signal. However, it may not be audible because the speaker is not actually capable of producing sound waves in this frequency range and/or because the people in the vicinity are not capable of hearing audio in this frequency range. While audio circuitry 212 may not have been originally intended for generating VLF radio signals and may not do so efficiently, only a very low strength VLF radio signal may be required because mobile electronic device 210 will be in close proximity to transponder 170 (e.g., within a few centimeters) when a transaction is being conducted. In some situations, mobile electronic device 210 may generate the VLF radio signals transmitted to transponder 170 using circuitry other than audio circuitry 212. For example the circuitry to generate the VLF radio signals may be included in a protective cover or case that is placed on mobile electronic device 210 or surrounds at least a portion of mobile electronic device 210. In other situations, mobile electronic device 210 may operate as described herein using a VLF frequency other than 17 kHz.

POS 230 include magnetic head 232. Magnetic head 232 is typically used by POS 230 to read magnetic stripes of payment cards that are swiped through or processed by POS 230. Magnetic head 232 may comprise an electromagnet that generates an electrical signal in response to being placed near, or otherwise exposed to, a magnetic field, such as a magnetic field of a magnetic stripe on a payment card or a magnetic field generated by transponder 170.

Since most modern mobile electronic devices are designed with audio circuitry, most mobile electronic devices may be used in accordance with the techniques introduced herein without adding any specialized hardware, hardware features, antennas, and/or transmitters for this purpose and without the need to attach a module or peripheral to the mobile electronic device. For example, some electronic payment systems utilize NFC. The techniques introduced here may be implemented without NFC functionality in the mobile electronic device, without the addition of an NFC peripheral or module to the mobile electronic device, and without NFC functionality in the POS terminal.

Similarly, a merchant may be able to use an existing POS terminal, such as POS 230, for conducting these types of transactions and avoid the possibility of having to upgrade or replace POS 230 with a device having specialized wireless communication hardware or features. Transponder 170 transforms a type of communication available from mobile electronic device 210 to a magnetic field that can be detected by POS 230. Using transponder 170, a merchant is able to offer a wireless or contactless payment solution that a large percentage of his or her customers will be able to utilize, without having to replace POS 230, and without disrupting an existing capability to process conventional payment cards. In some situations, an upgrade to firmware or software of POS 230 may be necessary to perform these features. However, most, if not all, of the benefits described herein may still be realized because it is not necessary to replace or modify the POS 230 hardware. POS firmware or software upgrades are often performed remotely and/or through a network connection or dial-up connection.

In the examples herein, a mobile electronic device, such as mobile electronic device 210, may electronically communicate other information to POS 230, in addition to the payment information. In one example, mobile electronic device 210 contains information about a user's grocery store loyalty or rewards account. This information is transferred to POS 230 along with the payment information in order for the user to get credit for the purchase. In other situations, a mobile electronic device may transfer other types of information to POS 230 before the payment information is transferred. For example, mobile electronic device 210 may transfer a user's health insurance information to POS 230 using the techniques described herein. POS 230 may then use the insurance information, or transfer it to another system, to determine the user's portion of a prescription purchase. Mobile electronic device 210 may then transfer the payment information as described herein to pay the user's portion.

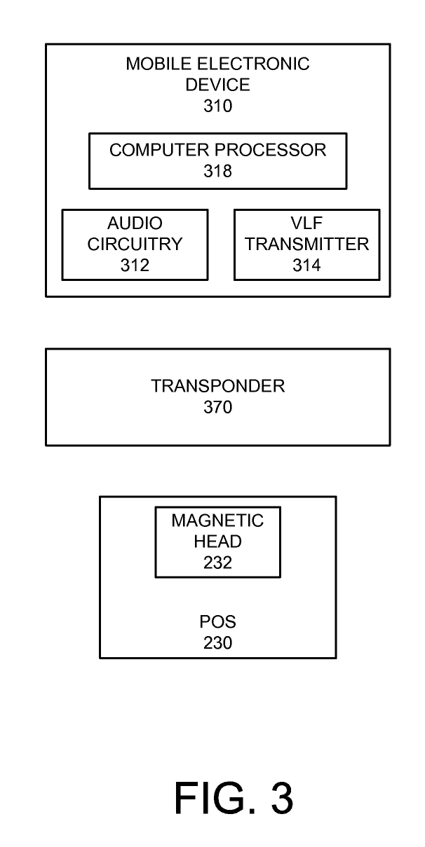

FIG. 3 illustrates devices for performing a financial transaction in accordance with the techniques introduced herein. FIG. 3 includes mobile electronic device 310, POS 230, and transponder 370.

Mobile electronic device 310 includes computer processor 318, audio circuitry 312, and VLF transmitter 314. Audio circuitry 312 is an example of audio circuitry 212. Transponder 370 is an example of transponder 170.

VLF transmitter 314 comprises circuitry for generating and transmitting modulated VLF radio signals in accordance with the techniques introduced herein. Although the VLF radio signals may be generated by audio circuitry 312 in some cases, it may be desirable to use a transmitter, such as VLF transmitter 314, that is specifically configured for and/or dedicated to generating the VLF radio signals.

Computer processor 318 comprises one or more computing cores, central processing units, microprocessors, microcontrollers, state machines, programmable logic arrays, and/or programmable logic devices. Among other functions, computer processor 318 generates signals causing audio circuitry 312 and/or VLF transmitter 314 to generate VLF radio signals containing the payment data.

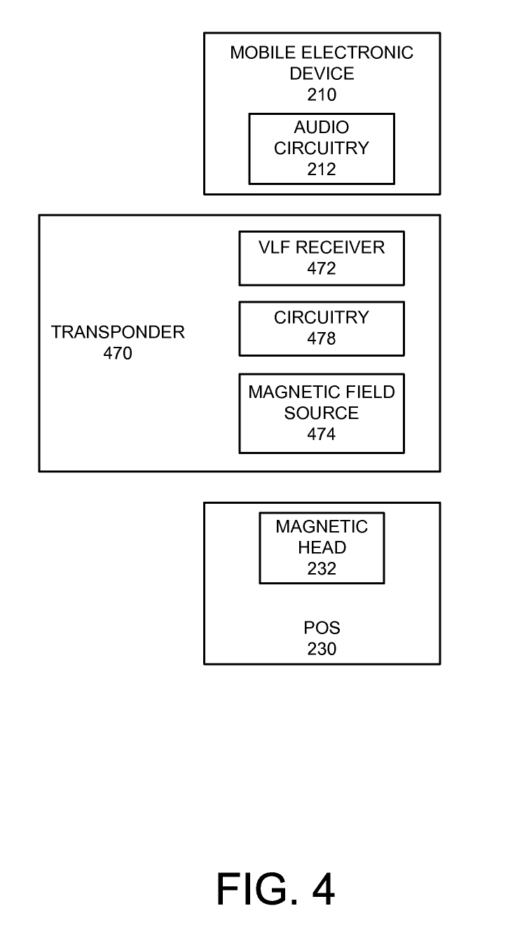

FIG. 4 illustrates transponder 470 for performing an electronic payment in accordance with the techniques introduced herein. Transponder 470 is an example of transponder 170 and/or transponder 370. Transponder 470 includes VLF receiver 472, circuitry 478, and magnetic field source 474. VLF receiver 472 comprises circuitry for receiving a VLF radio signal generated by mobile electronic device 210. VLF receiver 472 may be tuned to receive signals at a particular frequency or in a particular range of frequencies. In order to accommodate transmissions at various frequencies, VLF receiver 472 may be switchable among a number of frequencies. Alternately, transponder 470 may contain multiple VLF receivers, such as VLF receiver 472, for receiving signals having various frequencies and/or having other varying characteristics, such as modulation type. Magnetic field source 474 may comprise a coil, an electromagnet, or other device capable of generating or emanating a magnetic field. In some situations, transponder 470 may also be referred to as a coupler or a coupling module.

Circuitry 478 comprises electrical components for controlling and interfacing to VLF receiver 472 and magnetic field source 474 and for communicating payment data from one to the other. Circuitry 478 may include analog components, digital components, a microprocessor, a microcontroller, a digital signal processor, a state machine, a programmable logic arrays, and/or a programmable logic device. Circuitry 478 may also include a demodulator for demodulating VLF radio signals received from mobile electronic device 210 in order to recover the transmitted payment information. Circuitry 478 may also include a modulator for modulating a magnetic field generated by magnetic field source 474 to include the payment data.

Circuitry 478 may also include one or more audio or visual indicators (e.g., light emitting diode (LED), audible tone generator) for indicating one or more states of transponder 470. Various states that may be indicated include whether transponder is powered, whether VLF receiver 472 is currently receiving a VLF radio signal or carrier, and/or whether magnetic field source 474 is currently generating a magnetic field. In some cases, a synchronization step may be performed between mobile electronic device 210 and transponder 470 before the payment data is transmitted from mobile electronic device 210 to transponder 470. The synchronization step may include transmitting an unmodulated VLF signal, a carrier signal, and/or transmitting a test signal in order to verify that transponder 470 is properly receiving transmissions from mobile electronic device 210.

In one illustrative example, a user of mobile electronic device 210 is transmitting payment information to POS 230 to pay for a transaction. The user initiates the process using a software application running on mobile electronic device 210. For reasons of physical convenience, the user will typically be performing the initial steps of the process on mobile electronic device 210 before it is placed in proper proximity to transponder 470. The software instructs the user to place mobile electronic device 210 in a designated position near transponder 470 in preparation for the transaction. At that time, the software directs mobile electronic device 210 to transmit an unmodulated signal, a carrier signal, or a signal modulated with test or header data. When transponder 470 receives this signal, transponder 470 provides an audio or visual indication to the user. The user can then provide an input to the software causing the software to direct mobile electronic device 210 to transmit the payment information (e.g., modulate the payment information onto the carrier). This approach enables the user to verify that transponder 470 is correctly receiving data from mobile electronic device 210 before transmitting the payment data. This approach also reduces the likelihood of failed transmissions and/or having to transmit the payment data repeatedly.

The software application may provide varying levels of automation in making a payment for a transaction. In one example, the user may manually launch or open the software app and then manually approve a transaction. In another example, the software app may launch automatically but still require a manual entry or approval of the transaction from the user. In yet another example, the launching of the app and approval of the transaction may be fully automatic. The fully automatic mode may be limited by other criteria such as transaction location, transaction amount, and/or time of day. For example, the fully automatic mode may only be possible for transactions of twenty dollars or less.

In the cases of manual approvals, the user may signify approval of the transaction in one or more ways including: an entry on a touchscreen, a button press, a physical gesture, a voice command, placing the device in proximity to a transponder, biometric activation, entry of a password, entry of a pattern, and/or entry of a passcode.

While the examples above describe simplex communication between a mobile device and a transponder (e.g., one way communication from the mobile device to the transponder), alternate implementations may include bidirectional communication (e.g., half duplex communication, full duplex communication) between the mobile electronic device and the transponder. Bidirectional communication between the two devices may be used to further automate the synchronization process described above. A user may initiate the payment process, as described above, and the mobile electronic device and transponder may then communicate between each other to automatically complete the process after they have established reliable communication and/or synchronized communications with each other. In other words, when the transponder is properly receiving a carrier or test signal, the transponder may transmit a message back to the mobile electronic device indicating that state and directing the mobile electronic device to transmit the payment data without further involvement of the user.

Bidirectional communication between a mobile communication device and a transponder need not occur using the same type or format of communication. For example, even though mobile communication device 210 communicates to transponder 470 using VLF radio signals, transponder 470 may communicate back to mobile communication device 210 using another type of radio signal (e.g., Bluetooth®, Bluetooth Low Energy®, WiFi®, WiFi Direct®, NFC), an optical signal (e.g., visible light, infrared light, fiber optics), or one of the other methods described herein for communicating between a mobile communication device and a transponder. In other examples, the mobile communication device may receive communications from the transponder through one or more other sensors or input devices of the mobile communication device such as through a microphone, a magnetometer, an accelerometer, a camera, or an infrared sensor. In other examples, the mobile communication device may receive communications from the transponder through a direct electrical or cabled connection to the transponder.

Transponder 470 may have a mechanical design and/or physical configuration enabling it to be permanently, or semi-permanently, attached to POS 230. The attachment may be such that magnetic field source 474 is held in a preferred position and/or orientation with respect to magnetic head 232. In some configurations, transponder 470 may be positioned such that it can be left in place with respect to POS so that conventional payment card slides or insertions can still also be made at POS 230. In other configurations, magnetic field source 474 may be included in a fin, finger, or other thin mechanical portion of transponder 470 that can be inserted into a card slot of POS 230 thereby positioning magnetic field source 474 in close proximity to magnetic head 232 in order to maximize magnetic coupling between the two and/or to minimize the strength of the magnetic field necessary to achieve effective coupling. In this configuration, transponder 470 may be placed in different positions depending on whether the transaction will be conducted using the techniques disclosed herein or using a conventional payment card. In other words, transponder 470 may be placed on or near POS 230 such that a portion of it sticks into the card slot of POS 230 for electronic transactions. For conventional swiped card transactions, transponder 470 may be removed from POS 230 or pivoted or flipped away from the slot of POS 230.

Transponder 470 may have physical characteristics that provide assistance for positioning mobile electronic device 210 with respect to transponder 470 to achieve the desired communication. In one example, transponder 470 may have a shelf, slot, tray, or guide that mechanically receives or orients mobile electronic device 210 with respect to transponder 470. In another example, transponder may have graphics indicating how mobile electronic device 210 should be oriented with respect to transponder 470 (e.g., “face forward,” “bottom of phone here,” “power connector here”).

Transponder 470 may include components other than those illustrated in FIG. 4. Examples of other components include a power supply, a battery, a user interface, a display, a switch, a case, a frame, a visual indicator, an audible indicator, mechanical features for engaging one or more mobile electronic devices, mechanical features for engaging one or more POS terminals, graphically printed instructions, and/or one or more additional electrical interfaces.

In some cases, a variety of transponders, such as transponder 470, may be compatible with POS 230. A particular transponder may only be compatible with one or more brands/models/types of mobile electronic devices. In one example, one transponder may accommodate mobile phones while another transponder accommodates tablets. In another example, one transponder may accommodate one brand of mobile phone or electronic device while another transponder may accommodate another brand of mobile phone or electronic device. In yet another example, one transponder may accommodate one model of mobile phone while another transponder accommodates another model of the same brand of mobile phone. Alternately, a single transponder may accommodate two or more of these situations and may be manually or automatically switchable between different operational modes that support different devices.

While many of the examples described herein are described in the context of a mobile electronic device communicating with a transponder using VLF radio signals, the disclosed techniques may also be implemented using other types of communication between the two devices. Several non-limiting examples of alternate methods of communication between the mobile electronic device and the transponder are provided below.

In one example of an alternate method of communication between the mobile electronic device and the transponder, the mobile electronic device may communicate payment information to the transponder optically. The optical communication may be conducted using an LED of the mobile electronic device. For example, a status LED of the mobile electronic device may be toggled between on and off states, or varied in intensity, to communicate from the mobile electronic device to the transponder. In one variation of this example, an optical flash device associated with a camera of the mobile electronic device may be used as the optical source. In some situations, the LED, or other optical source, may not be part of the mobile electronic device and may be included in a case, cover, or peripheral for the mobile electronic device. In these examples, the transponder may use one or more optical receivers or sensors to detect the optical signals. The transponder may also utilize one or more mirrors, reflective elements, light pipes, fibers, lenses, and/or optical coupling devices to assist in capturing the optical signal from the mobile electronic device.

In another example of an alternate method of communication between the mobile electronic device and the transponder, the mobile electronic device may communicate payment information to the transponder using a display device of the mobile electronic device. The display device may be a liquid crystal display (LCD) of the mobile electronic device. The mobile electronic display device may display the payment information on the LCD in many forms including using a bar code, using a two dimensional bar code, using a three dimensional bar code, embedded in a picture, using a Quick Response (QR) code, using an optical machine-readable data representation in a proprietary format, and/or by displaying a graphical image or screen symbol of another type. The information may be displayed statically or dynamically. In some cases, an existing optical reader of a POS system may be used to read the information. For example, a merchant's POS system may have a bar code reader, a laser scanner, or a camera that is primarily intended for reading product information but can also be used to capture payment information that is graphically, optically, or visually displayed by the mobile electronic device. In some situations, a POS terminal, such as a gasoline dispending terminal, may have a bar code reader or other type of optical capture device for capturing other customer information or credentials, such as a bar code on a customer loyalty/rewards card. This type of secondary data capture hardware or capability may also be used for optically detecting or receiving payment information from the mobile communication device.

In yet another example of an alternate method of communication between the mobile electronic device and the transponder, the mobile electronic device may communicate with the transponder using an RF communication capability of the mobile communication device other than the VLF methods discussed above. The RF communication may be generated using a WiFi® radio of the mobile electronic device, using a WiFi Direct® radio of the mobile electronic device, using a Bluetooth® radio of the mobile communication device, using an NFC transmitter of the mobile electronic device, and/or using another RF radio or transmitter of the mobile electronic device. In some cases, one or more of the RF radios may be used to transmit payment information to the transponder even though the transmission is not compatible or compliant with a communication standard associated with the radio. For example, payment information may be communicated from the mobile electronic device to the transponder using the WiFi® radio but in a format that is not compatible with the WiFi® standard and/or without completing a typical WiFi® password setup process. The payment information may be encoded, encrypted, and/or modulated using an algorithm not typically used in WiFi® communications. The mobile electronic device may communicate with the transponder using one or more other types of wireless Internet connections.

In another variation, payment information may be communicated from the mobile electronic device to the transponder using a Bluetooth® radio or a using a Bluetooth® Low Energy radio but without completing an industry standard Bluetooth® device pairing process, or without completing any pairing process. In some cases, a universal pairing process may be used in which the mobile electronic device completes a pairing process with a transponder only a single time. In some cases, particular features, modes, or capabilities of the radio may be utilized to transmit the information in a preferential manner, such as using Bluetooth® power class 3, in order to reduce the strength of the transmitted signal.

In yet another example of an alternate method of communication between the mobile electronic device and the transponder, the mobile electronic device may communicate with the transponder using a mechanical method of communication. For example, many mobile electronic devices have a vibration mechanism for notifying a user of a call or a message. This vibration mechanism may be used to mechanically or haptically communicate information when the mobile electronic device is placed in contact with a transponder that is capable of detecting the vibrations. The transponder may include a vibration sensor for detecting the mechanical vibration. The payment information may be communicated via the vibration mechanism using an on-off keying modulation scheme, by varying the frequency of the vibration, by varying the intensity of the vibration, or a combination thereof.

In yet another example of an alternate method of communication between the mobile electronic device and the transponder, the mobile electronic device may communicate with the transponder using a wired connection between the mobile electronic device and the transponder. For example, a cable associated with the transponder may be attached to an electromechanical interface of the mobile electronic device, such as to an audio jack of the mobile electronic device. Payment data may be transferred from the mobile electronic device to the transponder over the cable. While attachment and use of a cable may be less convenient in some situations, this configuration still enables a merchant to utilize a transponder to adapt a conventional POS terminal to receive payment information electronically without replacing or modifying the POS terminal. In one configuration, the cable may be permanently attached to the transponder. In another configuration, the cable may be removably attached to the transponder. In the latter configuration, a plurality of cables may be available to accommodate various electromechanical interfaces of mobile electronic devices.

In yet another example of an alternate method of communication between the mobile electronic device and the transponder, the mobile electronic device may communicate with the transponder acoustically. For example, the mobile electronic device may transmit information acoustically from a speaker, earpiece, ringer, or other type of acoustical transducer of the mobile electronic device. The acoustical signals may be modulated, encrypted, or otherwise encoded with data or information that is to be transmitted from the mobile electronic device to the transponder. The transponder receives or detects the acoustical signals and demodulates, decodes, and/or decrypts the acoustical signals to recover the transmitted data or information.

In yet another example of an alternate method of communication between the mobile electronic device and the transponder, the mobile electronic device may communicate with the transponder through a direct electrical connection or through a hardwired connection. The communication may occur using one of a variety of formats or protocols and may be conducted using one or more types of standardized interfaces and/or connectors such as Universal Serial Bus (USB), Apple® 30 pin connector, Apple® Lightning connector, High-Definition Multimedia Interface (HDMI), or another type of electromechanical interface.

In addition, the transponder may communicate with the POS terminal in one or both directions in a variety of other manners including through a wired connection or through a wireless connection. In some cases, the transponder may communicate with the POS indirectly through one or more networks, devices, systems, the Internet, and/or some other element of a payment processing infrastructure.

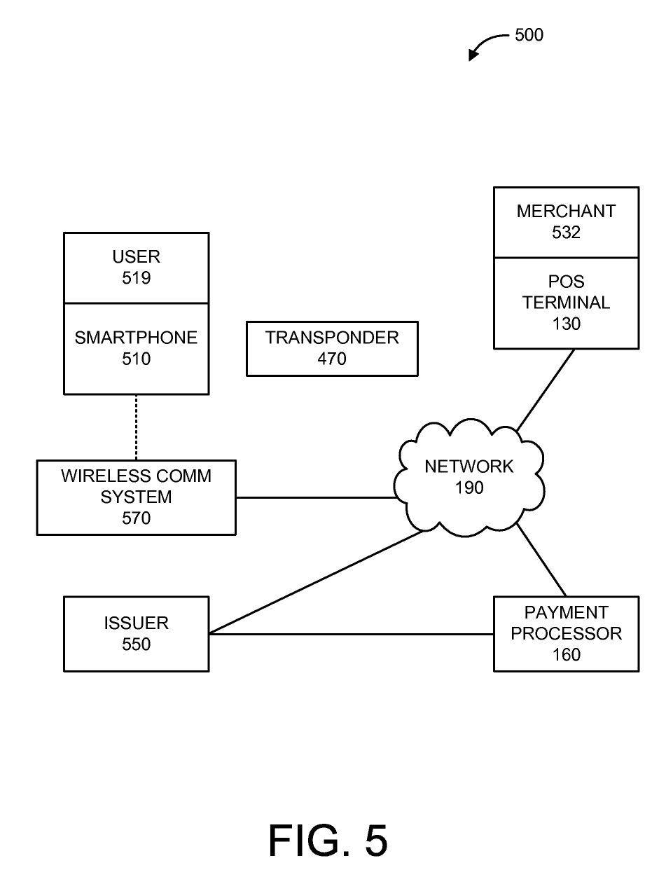

FIG. 5 illustrates electronic payment system 500 for performing transactions in accordance with the techniques introduced herein. Payment system 500 includes POS terminal 130, merchant 532, smartphone 510, user 519, wireless communication system 570, network 190, payment processor 160, and issuer 550.

Smartphone 510 is an example of mobile electronic device 110, mobile electronic device 210, and/or mobile electronic device 310. User 519 is any person or persons operating smartphone 510 and wishing to make an electronic payment for a financial transaction using smartphone 510. Merchant 532 is any person or business entity using POS terminal 130 to receive financial transaction payments.

Wireless communication system 570 comprises devices, systems, and/or components enabling smartphone 510 to communicate with other devices or systems through network 190. Wireless communication system 570 may include a cellular phone tower, an antenna, a base station, and/or a network interface for facilitating communications between smartphone 510 and other devices. In some cases, wireless communication system 570 may comprise a cellular data network or a portion of a cellular data network.

Issuer 550 comprises a bank, credit union, or other financial entity that issues or is associated with the issuing of financial accounts to users such as user 519. Issuer 550 is often involved in the transaction authorization process and/or provides payment to merchant 532, in conjunction with other entities, when a transaction is settled.

As described in other examples herein, payment information for a transaction between user 519 and merchant 532 can be transferred from smartphone 510 to POS terminal 130. Because smartphone 510 is capable of communicating with and receiving information from various types of computing and communication systems, additional features and/or functions are possible, as described below. These additional functions or features may provide further improvements over conventional magnetic stripe cards.

In one example, user 519 must enter a password into a user interface of smartphone 510 before a transaction is performed. Use of a password reduces the possibility that the account will be used fraudulently by someone who finds or gains access to smartphone 510. In addition to or in place of a conventional static password, other security or access control features may be provided to control use of the account. For example, use of the account, or even access to the account information, on smartphone 510 may be controlled by a dynamic password, a time-synchronized password, a password based on a mathematical algorithm, a biometric identifier, and/or a password generated by a security token. A security token may be a physical device such as a disconnected token, a connected token, a Bluetooth® token, or another type of secondary authorization factor. Any of these passwords, security features, tokens, and/or secondary authorization factors may be implemented within smartphone 510, within software running on smartphone 510, and/or in a separate device.

In some cases biometric security features or identifiers may include: handshake identifiers, tremor identifiers, heart rate data, facial recognition, eigenvectors, fingerprint data, voice recognition data, body resistivity measurements, optical/photographic recognition, odor data, DNA information, and/or handwriting recognition.

In another example, the payment information or account information may not be static information such as that encoded on a magnetic stripe of a payment card. The account number, some portion of the account number, or a field used in conjunction with the account number may change periodically. In other words, some type of variable account identifier may be used in addition to, or in place of, a conventional static account number. The variable account identifier may be obtained in a variety of ways. Even if another party somehow captures, records, or duplicates the transmission of information from smartphone 510 to POS terminal 130, the captured transmission cannot be reused or replayed in order to attempt to complete a transaction in a fraudulent manner because the information that was captured would not be valid for a subsequent transaction. Because the variable account identifiers or transaction codes may be stored in smartphone 510 in an electronic manner and because smartphone 510 has wireless communication capabilities, the identifiers or codes can be loaded or updated through a cellular data connection without inconveniencing the user. The updating of transaction codes, account information, and/or other security features may also be done periodically in an automated manner without direct involvement from the user.

In one example, smartphone 510 may generate the variable account identifier based on a mathematical algorithm, a logic based algorithm, and/or based on information that is received from another system, such as from a computing system of issuer 550. The information used to generate the variable account identifier may be received through wireless communication system 570 and/or network 190.

In yet another example, smartphone 510 may request a transaction code or variable account identifier from payment processor 160, issuer 550, and/or another device or entity in real time, or near real time, when a transaction is being conducted. After receiving the variable account identifier, smartphone 510 provides it to POS terminal 130. POS terminal 130 then provides it to payment processor 160 and/or issuer 550 in order to authorize the transaction. Using a transaction code in this manner provides an additional layer of protection against unauthorized use of the account because the information necessary to complete a transaction is not received until the time of the transaction.

In another example, the variable account identifier may be received by smartphone 510 from another device or system even though a transaction is not imminent, pending, or in progress. Later, when a transaction is being performed, POS terminal 130 can verify the variable account identifier with payment processor 160 and/or issuer 550 using processes similar to conventional transaction authorization processes. In other words, smartphone 510 may receive the transaction code or variable account identifier at one point in time, but not use it until a later point in time. In this example, the account has the added protection of the variable account identifiers and the convenience of receiving them electronically, but smartphone 510 does not necessarily need to have access to a data or network connection at the time of the transaction.

In one variation of the example above, a series of single-use transaction codes may be downloaded to smartphone 510 at one point in time and then individually used by smartphone 510 for transactions at various later points in time. In this example, transactions may be conducted using these single-use codes even though smartphone 510 may not be actively connected to wireless communication system 570 and/or network 190 at the time of the transactions or connected between the transactions. In some cases, a list of single or limited use transaction codes may be described as a “tear sheet.”

Other types of limited use transaction codes are also possible. A limited use transaction code may be valid for more than one transaction, but for no more than a specified number of transactions. Use of a transaction code may also be limited to: a specified period of time, a series of transactions not to exceed a total cumulative purchase amount, a specified period of time, a particular merchant or merchants, a particular geographic area, a particular category of goods, a particular category of goods, and/or may be limited by a maximum transaction amount.

Variable account numbers or codes may also be used to enable an employer or parent to manage spending of employees or children, respectively. For example, an employer may permit employees to load their smartphones with a base credit card account number that can be used for business expenses. However, a second variable portion of the account number or transaction code may also be needed to complete a transaction and the variable portion may be different for each employee for account or tracking reasons. In some cases, the second portion of the account number may only be provided on as-needed basis and may be subject to approval by the employer, possibly even on a real-time or near real-time basis. In other cases, the second portion of the account number not be loaded on a real-time basis, but may be subject to any of the limitations or controls discussed above such that a manager can control the amounts or types of transactions that the account is permitted to be used on. Each individual or group of individuals may have a different sub-account of the primary account that is subject to different limitations or controls. In other words, the employer or manager have a master account with a master account number where various sub-account of that master account have different characteristics or associated rules.

In some cases, information regarding multiple payment sources may be loaded on smartphone 510. These payment sources may include one or more of each of: credit card accounts, debit card accounts, prepaid accounts, mobile wallet accounts, electronic wallet accounts, electronic transaction accounts, gift card accounts, and/or merchant credit accounts.

In addition to using passwords or various other security features to control account use and control access to account information stored on smartphone 510, one or more additional security steps may be taken to protect the information while it is being communicated between smartphone 510 and POS terminal 130, to prevent tracking of transactions, and/or to prevent eavesdropping on transactions. For example, account information, transaction codes, and/or other information may be communicated to/from smartphone 510 and/or POS terminal 130 using one or more of a variety of known data security and/or encryption techniques such as public-key encryption or symmetric-key encryption.

Because the types of transactions discussed herein are performed using a smartphone, or other mobile electronic device, additional account features may also be enabled. In one example, additional information about the performed transactions may be more easily gathered. Information such as time of transaction, owner of the device, specific location where the transaction was completed, and/or other information related to the transaction, may be received from the smartphone by the POS terminal in addition to the information that is conventionally provided in card processing processes. This additional information may be transmitted to the POS terminal by the electronic device and included with the information sent to the payment processor or may be independently gathered form the mobile electronic device through one or more other networks or communication paths. This information may be beneficial to the merchant, the user, and/or other entities such as a marketing agency.

In another example of improved account features, a user who uses a mobile electronic device may receive an electronic receipt, or other documentation associated with the transaction, electronically. The receipt or documentation may be received by the mobile electronic device through two way communication with the transponder or may be received over a wireless communication network. The electronic receipt or documentation may be provided in place of or in addition to conventional paper receipts and documentation. Examples of additional documentation that may be received electronically are: offers for future visits, coupons, product warranty information, service reminder messages, electronic receipts configured for import into a financial management software program, rewards account information, and loyalty account information.

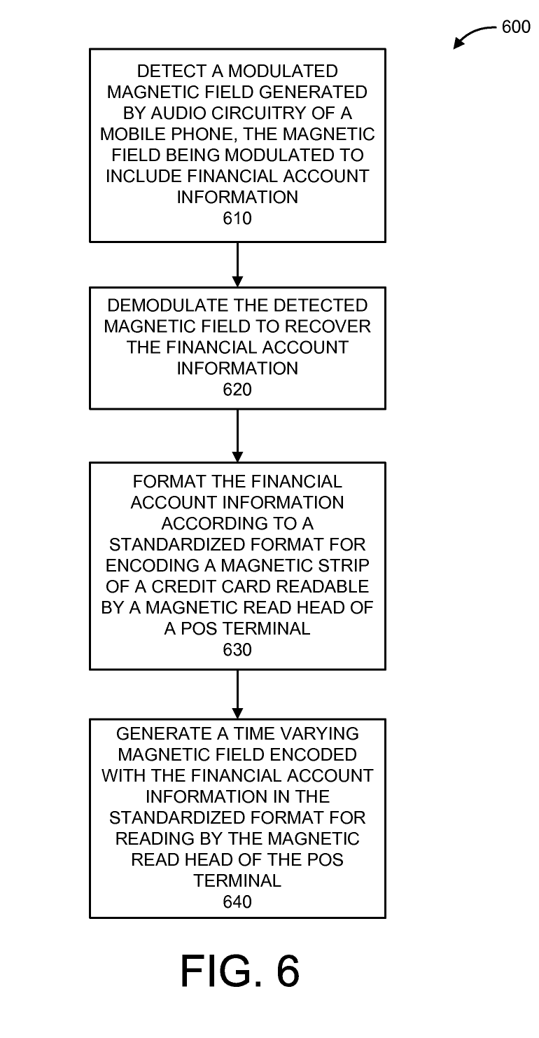

FIG. 6 illustrates method 600 of performing an electronic payment in accordance with the techniques introduced herein. At step 610, method 600 includes detecting a modulated magnetic field generated by audio circuitry of a mobile phone, the magnetic field being modulated to include the financial account information. At step 620, method 600 includes demodulating the detected magnetic field to recover the financial account information. At step 630, method 600 includes formatting the financial account information according to a standardized format for encoding a magnetic strip of a credit card readable by a magnetic read head of a POS terminal. At step 640, method 600 includes generating a time varying magnetic field encoded with the financial account information in the standardized format for reading by the magnetic read head of the POS terminal.

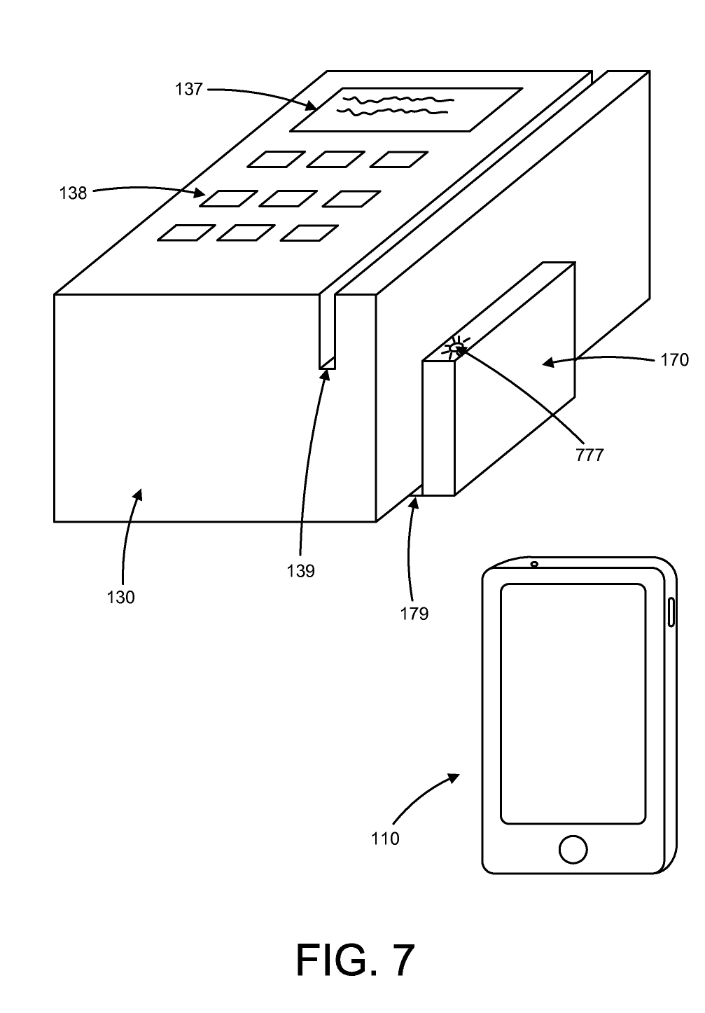

FIG. 7 illustrates transponder 170 attached to POS terminal 130 in accordance with the techniques introduced herein. POS terminal 130 includes one or more magnetic sensors (not visible in FIG. 7) that read or sense information from a magnetic stripe of a payment card. Magnetic head 232 is one example of a magnetic sensor. POS terminal 130 may also include user interface elements such as keypad 138 and display 137 to permit a merchant or other user of POS terminal 130 to make data entries and/or view information. Other user interface features and functions are possible.

In FIG. 7, transponder 170 is attached to POS terminal 130. Transponder 170 has a preferred position and/or orientation with respect to POS terminal 130 such that magnetic fields generated by transponder 170 may be sensed by the one or more magnetic sensors of POS terminal 130. Transponder 170 may be kept in this position by a mechanical component, such as bracket 179, that attaches transponder 170 to POS terminal 130. Transponder 170 may also be held in position in other ways including with an adhesive, a screw, a bolt, a hook-and-loop fastener, a suction cup, a clip, a snap, another type of fastener, or any combination thereof. It should be understood that transponder 170 need not be attached to POS terminal 130 in order to operate or to perform the techniques described herein. However, attachment may be convenient for purposes of maintaining a preferred position of transponder 170. In some cases, POS terminal 130 and/or transponder 170 may each be attached to another device or surface, such as a checkout counter, in order to maintain the spatial relationship between them. Transponder 170 also optionally includes visual indicator 777 that indicates a state, status, or condition associated with transponder 170.

While transponder 170 is illustrated as being positioned on a side of POS terminal 130, it should be understood that many other orientations are possible, including on a front, back, top, bottom, or alternate side of POS terminal 130. In some cases, transponder 170 may be positioned inside POS terminal 130. For example, POS terminal 130 may be part of a gasoline dispensing terminal that accepts magnetic stripe cards. Transponder 170 may be placed inside of the terminal near internal components of the terminal that are associated with reading a magnetic stripe card.

In some variations, all of the components of transponder 170 may not be in a single case, shell, or housing. For example, transponder 170 may include a receiver that is in one housing while having a source in another housing such that one or both can be placed in preferred locations with respect to POS terminal 130. The preferred location(s) may be locations that are better suited for receiving data from mobile electronic device 110 and/or may be locations better suited for communication with POS terminal 130.

In some cases, a merchant may be using a conventional POS terminal, such as POS terminal 130, for processing credit and debit card payments made using conventional magnetic stripe cards. The merchant may then obtain transponder 170 in order to adapt his or her existing POS terminal 130 to receive payment information wirelessly as described herein, while still maintaining the capability to process magnetic stripe cards in a conventional manner using slot 139. In some cases, transponder 170 may be powered by a battery or other power source that is internal to transponder 170. In other cases, transponder 170 may be attached to an external power source. In yet other cases, transponder 170 may be electrically interconnected to POS terminal 130 and may receive power from POS terminal 130. In yet other cases, transponder 170 may harvest energy for operation from a VLF signal and/or from a magnetic field.

In one example of operation, a user of mobile electronic device 110 uses mobile electronic device 110 to make a contactless payment at POS terminal 130. Mobile electronic device 110 contains and/or has access to account information that will be used to make the payment. The user may first make one or more entries or selections using a user interface of mobile electronic 110 and/or a software application as described in other examples herein. The user may alternately make entries or selections using a voice command.

Mobile electronic device 110 generates a VLF signal that is modulated using the account information. The VLF signal can be received by transponder 170 when mobile electronic device 110 is placed in proximity to transponder 170. Transponder 170 may have printed graphics or instructions to help the user determine the proper orientation of mobile electronic device 110. Indicator 777 may provide a visual indicator to the user when transponder 170 is receiving the VLF signal. For example, indicator 777 may be an LED that illuminates or changes colors when the VLF signal is received and/or when some characteristic of the VLF signal is detected. Transponder 170 receives the VLF signal and demodulates it to obtain the account information. Transponder 170 then generates a time-varying magnetic field based on the account information in order to communicate the account information to POS terminal 130.

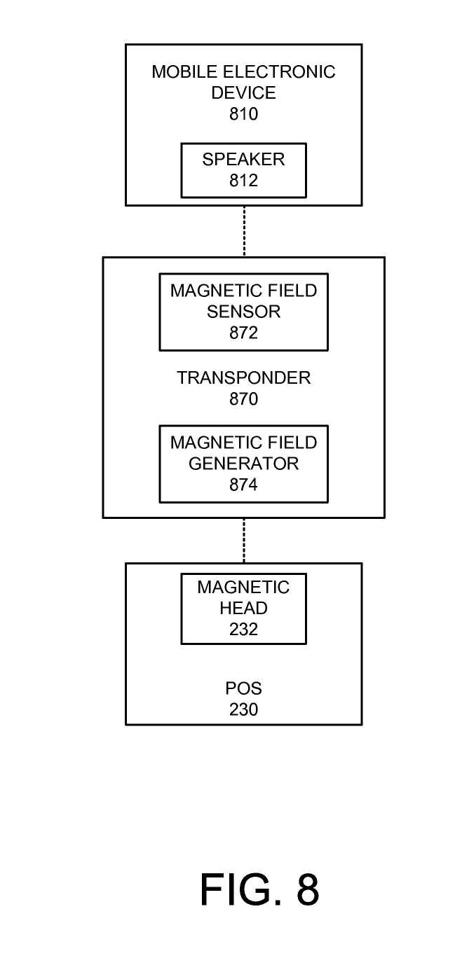

FIG. 8 illustrates devices for performing a financial transaction in accordance with the techniques introduced herein. In the example of FIG. 8, digital information is communicated from a mobile electronic device to a transponder and from a transponder to a POS terminal using magnetic fields. In some situations, even though a mobile electronic device may be capable of generating magnetic fields, it may be undesirable to attempt to transmit directly from the mobile electronic device to a POS terminal. This may be true for a variety of reasons. In one example, the mobile electronic device may not be configured or equipped to generate a strong enough magnetic field to be received, or reliably received, by a read head of the POS.

In another example, the mobile electronic device may be capable of generating a strong enough magnetic field to be received by the POS but it may be undesirable to do so due to the relatively loud audio waves that are created when doing so and/or because the data may be transmitted in an unencrypted format. In yet another example, the mechanical configuration of the POS and/or magnetic head may be such that it is difficult to get the mobile electronic device or speaker close enough to the magnetic head, or in a desirable orientation with respect to the magnetic head, such that coupling between them is sufficient. In a further example, the mobile electronic device may not encode or modulate data in a format that is compatible with the POS or may have some other incompatibility with the POS. For any of these reasons, or for other reasons, it may be necessary or desirable to use a transponder in order to interface the mobile electronic device to the POS.

FIG. 8 includes mobile electronic device 810, transponder 870, and POS 230. Mobile electronic device 810 is an example of mobile electronic device 110, 210, 310, and/or smartphone 510. Mobile electronic device 810 includes speaker 812. Speaker 812 comprises an audio speaker or loudspeaker. Speaker 812 may be an electroacoustic transducer that produces sound waves in response to an electrical signal from mobile electronic device 810. Speaker 812 is typically driven for purposes of generating audible sound waves that are heard in proximity of mobile electronic device 810. However, in accordance with the techniques disclosed herein, speaker 812 may be electrically driven for the purpose of generating a time-varying magnetic field for communicating payment information to another device.

Transponder 870 includes magnetic field sensor 872 and magnetic field generator 874. Magnetic field sensor 872 comprises any device capable of receiving or detecting a magnetic field generated by speaker 812 of mobile electronic device 810. For example, magnetic field sensor 872 may comprise a coil or an inductor. Magnetic field generator 874 is a magnetic field source, coil, electromagnet, or other device capable of generating or emanating a magnetic field. Transponder 870 may also include other components such as one or more of: an analog electrical component, a digital electrical component, a microprocessor, a microcontroller, a memory, an audible indicator, a visual indicator, and a power supply. Transponder 870 receives or detects a first magnetic field generated by mobile electronic device 810 that is modulated, encoded, or otherwise varied to contain data. Transponder 870 generates a second magnetic field containing some or all of the data that was received in the first magnetic field. The second magnetic field is received or detected by magnetic head 232 of POS 230.

Although both the communication from mobile electronic device 810 to transponder 870 and the communication from transponder 870 to POS 230 are performed using magnetic fields, the two communications may have differences related to one or more of the potential incompatibilities or problems discussed above. Transponder 870, using magnetic field generator 874, may generate a magnetic field that is stronger and/or has a different magnetic orientation than the magnetic field detected at magnetic field sensor 872. Transponder 870 may also transform the communication in other ways including: changing the modulation scheme, changing the data format, changing or adding an encoding scheme, changing the bit rate, signal conditioning, reordering the data, adding data, and/or removing data.

In addition, transponder 870 may perform one or more checks or validation steps on the received data. Transmission of the data from transponder 870 to POS 230 may be conditioned on successfully satisfying the checks or validations. For example, transponder 870 may execute an error checking algorithm to determine if valid data was properly received from mobile electronic device 810 before the data, or a variation or derivation of the data, is transmitted to POS 230. In some cases, transponder 870 may perform error correction on the received data and/or may supplement the data with error correction information, or additional error correction information, before it is transmitted to POS 230. In some cases, transponder 870 may check one or more fields of the data to determine if the field contains a valid entry. In one example, transponder 870 may check the data contained in an expiration date field to determine if it is populated with a valid date. Transponder may contain visual and/or audio indicators to indicate various states including: ready, idle, receiving data, data received, valid data received, invalid data received, or transmitting data.

Transponder 870 may have a mechanical design and/or physical configuration enabling it to be permanently, or semi-permanently, attached to POS 230. The attachment may be such that magnetic field generator 874 is held in a preferred position with respect to magnetic head 232. In some cases, magnetic field generator 874 may be include in a fin, finger, or other thin mechanical portion that can be inserted into a card slot of POS 230 thereby positioning magnetic field generator 874 in close proximity to magnetic head 232 in order to maximize magnetic coupling between the two and/or minimize the strength of the magnetic field necessary to achieve effective coupling. In some cases, transponder 870 may need to be removed from POS 230 in order to perform conventional payment card slides or insertions in POS 230. In other cases, transponder 870 may be positioned such that it can be left in place while conventional payment card slides or insertions occur. In some cases, transponder 870 may be configured as a small self-contained device, or “puck,” that is placed on or near POS 230.

Transponder 870 may also have a physical design and/or may be printed with graphics indicating how mobile electronic device 810 should be oriented with respect to transponder 870 to achieve the desired magnetic coupling between speaker 812 and magnetic field sensor 872. For example, transponder 870 may have a shelf or slot that mechanically receives or orients and end of mobile electronic device 810 and/or may have graphics indicating how mobile electronic device 810 should be oriented with respect to the slot or shelf (e.g., “position face forward,” “place bottom of device here,” “place phone power connector here,” etc.).

Transponder 870 may include components other than those illustrated in FIG. 8. Examples of other components include a power supply, a battery, a user interface, a display, a switch, a case, a rigid frame, mechanical features for engaging one or more mobile electronic devices, mechanical features for engaging one or more POS terminals, graphically printed instructions, and/or one or more additional electrical interfaces.

In some examples, the mobile electronic device in the various examples herein may be an electronic device other than a smartphone. For example, the mobile electronic device that provides the payment information may be an electronic tag such as an NFC tag, an RFID tag, a Bluetooth tag, a Bluetooth low energy tag, or similar device. In this example the payment information is stored in the electronic tag and transmitted to the transponder from the electronic tag. The electronic tag may receive power from the transponder or from another device.

The communication techniques described herein may also be used in other applications to communicate between a mobile electronic device and another device. In one example, a mobile communication device may use the communication methods described herein to communicate with an electronic door lock or security system such that the mobile electronic device can be used to open a lock, open a door, open a gate, access a room, unlock a vehicle, access some other type of secured device or area, and/or perform a related task. In some cases, the mobile electronic device may be capable of communicating with and/or controlling a home automation system.

In another example of alternative applications of the communication methods described herein, a mobile communication device may communicate information to one or more computing devices or systems such as: a desktop computer, a laptop computer, a server, an Internet terminal, a medical records system, a gambling device, a gaming device, and/or an entertainment device. In addition to or in place of transaction payment information, the mobile communication device may communicate information such as driver's license information, insurance information, contact information, business card information, location information, an address, a digital picture, and/or an electronic file.

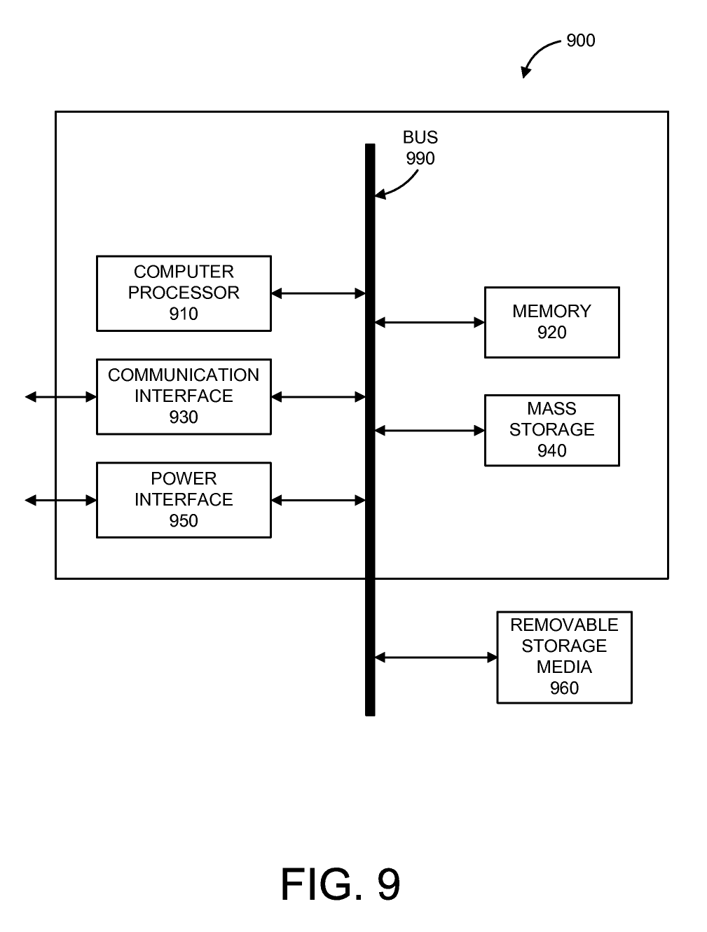

FIG. 9 illustrates computer system 900 with which some embodiments of the techniques disclosed herein may be implemented or utilized. A computing system, such as computing system 900, may be used to implement one or more of the techniques described herein, in whole or in part.

According to the example of FIG. 9, computer system 900 includes a bus 990, at least one computer processor 910, at least one communication interface 930, at least one memory 920, at least one mass storage device or module 940, and at least one power interface 950. A removable storage media 960 may also interface to bus 990 of computer system 900.

Computer processor 910 can be any known computer processor, central processing unit, microprocessor, microcontroller, digital signal processor, state machine, programmable logic array, or programmable logic device. Computer processor 910 may also include or interface to a coprocessor.

Communication interface 930 can be any type of interface for communicating with another device or a network, such as network 190. Communication interface 930 may be configured for communicating using a wired connection, a wireless connection, audio signals, light waves, infrared signals, or a combination thereof. Communication interface 930 may be configured for communicating with or over a network such a Local Area Network (LAN), Wide Area Network (WAN), or any network to which computer system 900 connects. Communication interface 930 may also be configured to communicate with an electronic device such as a cellular phone, a smartphone, a tablet, a laptop computer, a server, an audio device, and/or a multimedia device. The various functions of communication interface 930 may be distributed across multiple communication interfaces. In one example, communication interface 930 is a USB interface.

Memory 920 can include random access memory (RAM), or any other type of dynamic data storage device commonly known in the art. Memory 920 may also include one or more static storage devices such as read only memory (ROM), programmable read only memory (PROM), flash memory, magnetic memory, erasable programmable read only memory (EPROM), and/or electrically erasable programmable read only memory (EEPROM) for storing static data such as firmware or machine-executable instructions for computer processor 910 or for another computer processor.

Mass storage 940 can include one or more persistent mass data storage devices or modules that may be used to store data, information, and/or instructions. Mass storage 940 may include a hard drive, a tape drive, an optical drive, flash memory, a micro electromechanical (MEMs) storage device, or a combination thereof.

Power interface 950 can be any type of interface for receiving and/or transmitting electrical power. The functions of power interface 950 may be spread across multiple power interfaces. Power interface 950 may include a battery and may interface to external devices for purposes of charging the battery. The functions of power interface 950 may also be combined into a single connector and/or interface with communication interface 930. For example, the functions of communication interface 930 and power interface 950 may both be implemented in the form of one or more USB interfaces.

Removable storage media 960 can be any kind of external data storage device including a hard drive, a memory card, a subscriber identity module (SIM) card, flash memory, an optical drive, a tape drive, a micro electromechanical storage device, or a combination thereof.

Bus 990 communicatively couples the elements of computer system 900, as well as removable storage media 960. Bus 990 may conform to an industry standard bus architecture and protocol or may use a proprietary architecture and/or protocol.

Some or all of the steps and operations associated with the techniques introduced herein may be performed by hardware components or may be embodied in machine-executable instructions that cause a general purpose or special purpose computer processor programmed with the instructions to perform the steps. Alternatively, the steps may be performed by a combination of hardware, software, and/or firmware.

The apparatuses, systems, methods, and components described herein are meant to exemplify some types of possibilities. In no way should the aforementioned examples limit the scope of the invention, as they are only exemplary embodiments.

The foregoing disclosure has been presented for purposes of illustration and description. Other modifications and variations may be possible in view of the above teachings. The examples described in the foregoing disclosure were chosen to explain the principles of the concept and its practical application to enable others skilled in the art to best utilize the invention. It is intended that the claims be construed to include other alternative embodiments of the invention except as limited by the prior art.

The phrases “in some embodiments,” “according to some embodiments,” “in the embodiments shown,” “in other embodiments,” “in some examples,” “in some cases,” “in some situations,” “in one configuration,” “in another configuration” and the like generally mean that the particular feature, structure, or characteristic following the phrase is included in at least one embodiment of the present invention and/or may be included in more than one embodiment of the present invention. In addition, such phrases do not necessarily refer to the same embodiments or different embodiments.

What is claimed is:

1. A transponder for facilitating financial transaction communications, the transponder comprising:
a detector for detecting a first time varying magnetic field generated by a mobile electronic device, the first time varying magnetic field being encoded with financial account information;
a processing module for decoding the first time varying magnetic field detected by the detector to recover the financial account information; and
a magnetic field source for generating a second time varying magnetic field for detection by a magnetic read head of a point-of-sale (POS) terminal, the second time varying magnetic field being modulated with the recovered financial account information according to a sequence, the sequence corresponding to a standardized format for encoding a magnetic strip of a credit card that is readable by the magnetic read head of the POS terminal.

2. The transponder of claim 1 wherein the first time varying magnetic field is generated using an audio speaker coil of the mobile electronic device, and the detector is tuned to detect the time varying magnetic field generated by the audio speaker coil of the mobile electronic device.

3. The transponder of claim 1 wherein the processing module is configured to recover the financial account information using a decryption algorithm corresponding to an encryption algorithm used by the mobile electronic device to encrypt the financial account information.

4. The transponder of claim 1 wherein the sequence is applied according to ISO/IEC 7813.

5. The transponder of claim 1 further comprising an indicator for generating a status indication to a user of the mobile electronic device when the processing module has decoded the detected time varying magnetic field, the indicator including one or more of a visual indicator and an audible indicator.

6. The transponder of claim 1 wherein the processing module decodes the electrical signal using a phase shift keying (PSK) demodulation algorithm.

7. The transponder of claim 1 wherein the processing module decodes the electrical signal using a frequency shift keying (FSK) demodulation algorithm.

8. The transponder of claim 1 wherein modulating the second time varying magnetic field includes reversing a polarization of the second time varying magnetic field.

9. The transponder of claim 1 wherein the first time varying magnetic field generated by the mobile electronic device has a frequency in a range of 3 kHz to 30 kHz.

10. The transponder of claim 1 wherein the first time varying magnetic field generated by the mobile electronic device has a frequency in a range of 300 Hz to 3 kHz.

11. The transponder of claim 1 wherein the first time varying magnetic field generated by the mobile electronic device has a frequency in a range of 30 Hz to 300 Hz.

12. An apparatus for facilitating financial transaction communications between a mobile electronic device and a point-of-sale (POS) terminal, the apparatus comprising:
a magnetic field sensing module configured to:
detect a time varying magnetic field generated by the mobile electronic device; and
generate an electrical signal based on the detected time varying magnetic field, the time varying magnetic field being modulated with financial account information;
processing circuitry configured to:
receive the electrical signal from the magnetic field sensing module; and
demodulate the electrical signal to recover the financial account information from the electrical signal; and
a magnetic field generation module configured to generate a second time varying magnetic field for detection by a magnetic read head of the POS terminal, the second time varying magnetic field being modulated with the financial account information according to a format, the format corresponding to a standardized format for encoding a magnetic strip of a credit card readable by the magnetic read head of the POS terminal.

13. The apparatus of claim 12 wherein the financial account information modulated in the time varying magnetic field is encrypted, and the processing circuitry executes a decryption algorithm to decrypt the encrypted financial account information.

14. The apparatus of claim 12 wherein the format is specified by ISO/IEC 7813.

15. The apparatus of claim 12 wherein the detected time varying magnetic field has a frequency in a range of 300 Hz to 30 kHz.

16. The apparatus of claim 12 further comprising receiver circuitry for receiving a communication from the POS terminal in response to the generation of the second time varying magnetic field.

17. A method of communicating financial transaction information between a mobile phone and a point-of-sale (POS) terminal, the method comprising:
detecting a modulated magnetic field generated by audio circuitry of the mobile phone, the magnetic field being modulated to include the financial account information;
demodulating the detected magnetic field to recover the financial account information;
formatting the financial account information according to a standardized format for encoding a magnetic strip of a credit card readable by a magnetic read head of the POS terminal; and
generating a time varying magnetic field encoded with the financial account information in the standardized format for reading by the magnetic read head of the POS terminal.

18. The method of claim 17 wherein the standard format is compliant with ISO/IEC 7813.

19. The method of claim 17 wherein demodulating the detected magnetic field to recover the financial account information includes applying phase shift keying (PSK) demodulation to the detected magnetic field.

20. The method of claim 17 wherein demodulating the detected magnetic field to recover the financial account information includes applying frequency shift keying (FSK) demodulation to the detected magnetic field.

21. The method of claim 17 further comprising:
receiving a message from the POS terminal; and
transmitting the message for delivery to the mobile phone.

22. A system for facilitating financial transaction communications between a mobile electronic device and a point-of-sale (POS) terminal, the system comprising:
a set of non-transitory, computer executable instructions that, when executed by one or more computer processors of the mobile electronic device, direct the one or more computer processors to transmit electrical signals to an audio speaker coil of the mobile electronic device to generate a first magnetic field, the electrical signals encoded to include financial account information such that the first magnetic field is modulated with the financial account information; and
a transponder configured to:
detect the first magnetic field;
demodulate the detected magnetic field to recover the financial account information; and
generate a second magnetic field for detection by a magnetic read head of the POS terminal to complete a financial transaction, the second magnetic field being modulated with the financial account information according to a sequence, the sequence corresponding to a standardized format for encoding a magnetic strip of a credit card that is readable by the magnetic read head of the POS terminal.

23. The system of claim 22 wherein the set of instructions further direct the one or more computer processors of the mobile electronic device to receive an input from a user of the mobile electronic device before transmitting the electrical signals to the audio speaker coil.

24. The system of claim 22 wherein the input from the user includes a password that is verified by the one or more computer processors before transmitting the electrical signals to the audio speaker coil.

25. The system of claim 24 wherein the sequence is specified by ISO/IEC 7813.

26. The system of claim 22 wherein the set of instructions further direct the one or more computer processors of the mobile electronic device to receive the financial account information from a user of the mobile electronic device prior to the financial transaction.
